(19) United States
(12) Patent Application Publication
(10) Pub. No.: US 2021/0061655 A1
(43) Pub. Date: Mar. 4, 2021

(54) AN INTEGRATED AND TUNABLE SYSTEM FOR THE PRODUCTION OF SYNGAS AND CHEMICALS VIA SOLAR-ASSISTED ELECTROLYSIS AND COMBINED REFORMING

(71) Applicant: The Texas A&M University System, College Station, TX (US)

(72) Inventors: Mahmoud M. El-Halwagi, College Station, TX (US); Juliet E. Campbell, College Station, TX (US)

(21) Appl. No.: 16/962,440

(22) PCT Filed: Jan. 24, 2019
(86) PCT No.: PCT/US2019/014922

§ 371 Date: Jul. 15, 2020

Related U.S. Application Data
(60) Provisional application No. 62/622,317, filed on Jan. 26, 2018.

(51) Int. Cl. C01B 3/36; C01B 3/50; B01J 19/24; C25B 1/04; C25B 15/08

(52) U.S. Cl. CPC C01B 3/36; C01B 3/50; B01J 19/24; C25B 1/04; C25B 15/08; C01B 2203/84; C01B 2203/0238; C01B 2203/025; C01B 2203/0465; C01B 2203/0827; C01B 2203/0233

(57) ABSTRACT

A method and system for producing syngas The method includes providing separate streams of oxygen gas and hydrogen gas, the oxygen gas and the hydrogen gas generated from electrolysis of water. The separate stream of oxygen gas is introduced into a reforming module configured to generate a reformed syngas feed, where the oxygen gas oxidizes natural gas supplied to the reforming module. The separate stream of hydrogen gas and the reformed syngas feed are mixed to adjust a ratio of hydrogen gas to carbon monoxide gas (H₂:CO) to produce a syngas product feed. The system includes a reforming module to receive a stream of oxygen gas, where the oxygen gas oxidizes natural gas supplied to the reforming module to generate a reformed syngas feed. The system includes a mixing module to receive the reformed syngas feed and a stream of hydrogen gas to thereby adjust a ratio of hydrogen gas to carbon monoxide gas (H₂:CO) in a syngas product feed released from the mixing module. The stream of oxygen gas and the stream of hydrogen gas are generated from electrolysis of water.

### CROSS-REFERENCE TO RELATED APPLICATION

This application claims the benefit of U.S. Provisional Application Ser. No. 62/622,317, filed by Mahmoud M. El-Halwagi, et al. on Jan. 26, 2018, entitled “AN INTEGRATED AND TUNABLE SYSTEM FOR THE PRODUCTION OF SYNGAS AND CHEMICALS VIA SOLAR ASSISTED ELECTROLYSIS AND COMBINED REFORMING,” commonly assigned with this application and incorporated herein by reference.

### TECHNICAL FIELD

This application is directed, in general, to method and an integrated system and, more specifically, to an integrated and tunable system for the production of synthesis gas (“syngas”) and downstream production chemicals via solar-assisted electrolysis and combined reforming.

### BACKGROUND

Global energy demands are rapidly increasing. With the global population expected to exceed 9 billion by 2040, the demands and requirements for energy production, storage, and distribution will only increase. To meet these increasing energy demands, new and optimized processes will need to be developed and implemented.

### BRIEF DESCRIPTION

Reference is now made to the following descriptions taken in conjunction with the accompanying drawings, in which:

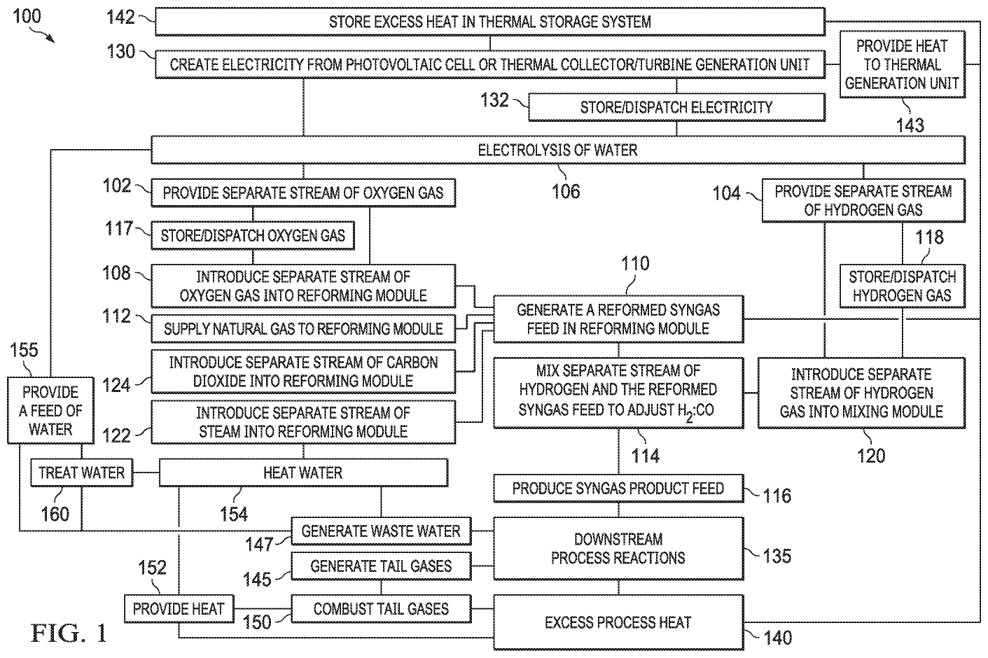

FIG. 1 presents a flow diagram of a method for producing syngas in accordance with the disclosure;

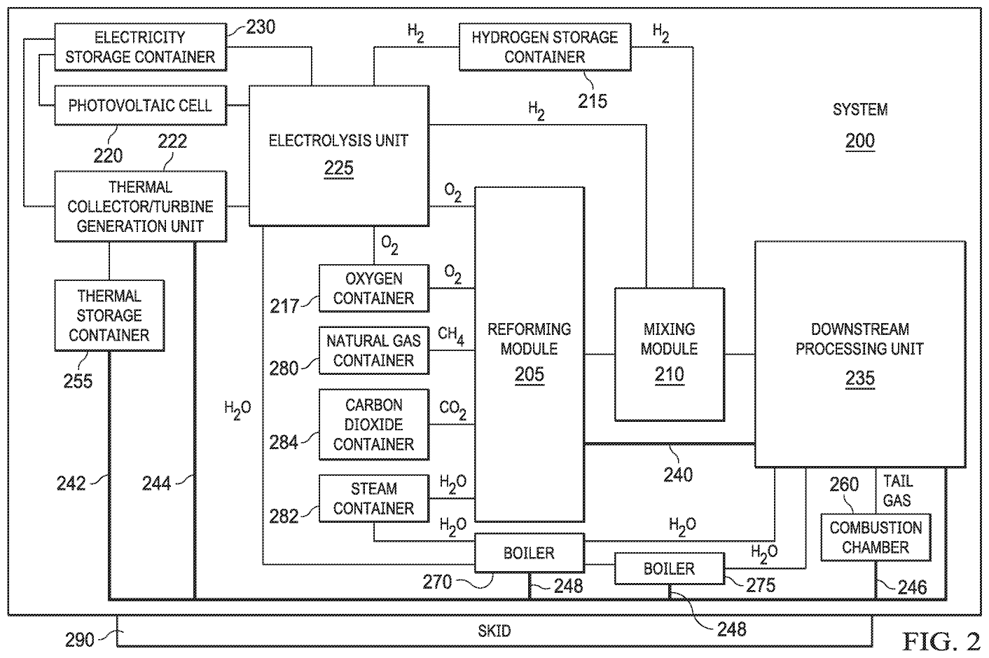

FIG. 2 presents a block diagram of a system for producing syngas in accordance with the disclosure;

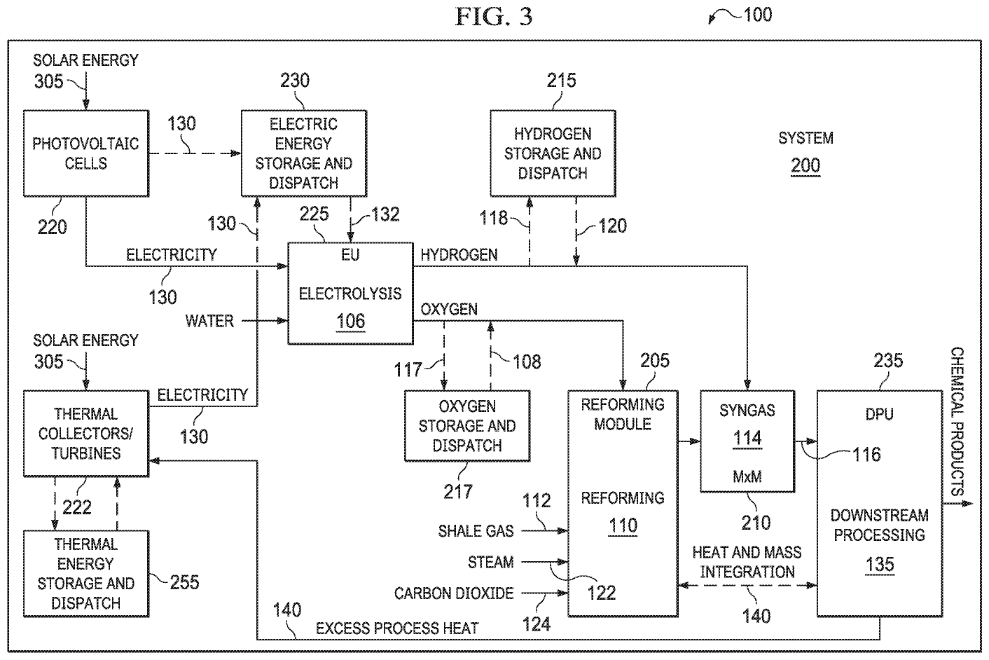

FIG. 3 presents a process flow and system block diagram of another example of the method and system for producing syngas in accordance with the disclosure;

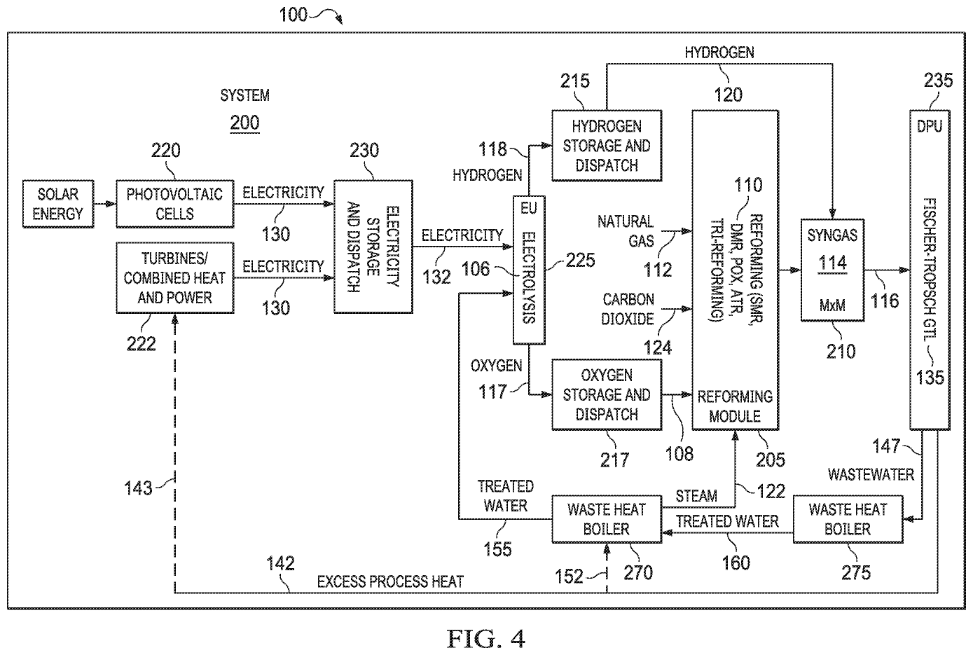

FIG. 4 presents a process flow and system block diagram of another example of the method and system for producing syngas in accordance with the disclosure, with mass and heat integration of syngas production with a Fischer-Tropsch process;

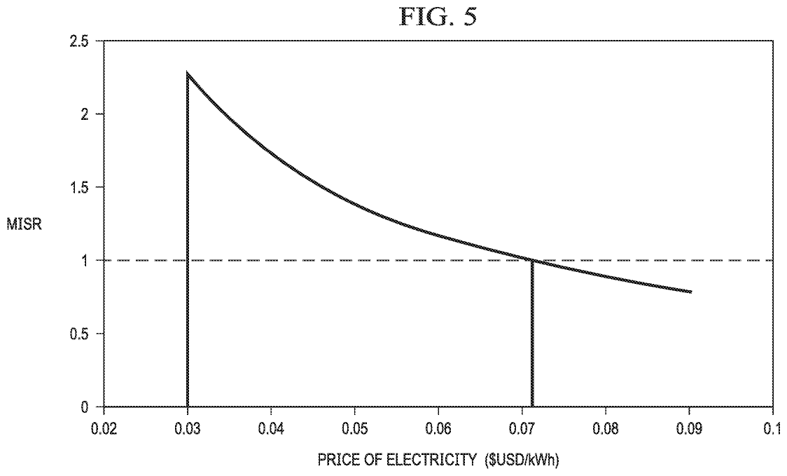

FIG. 5 illustrates MISR sensitivity with electricity in water electrolysis;

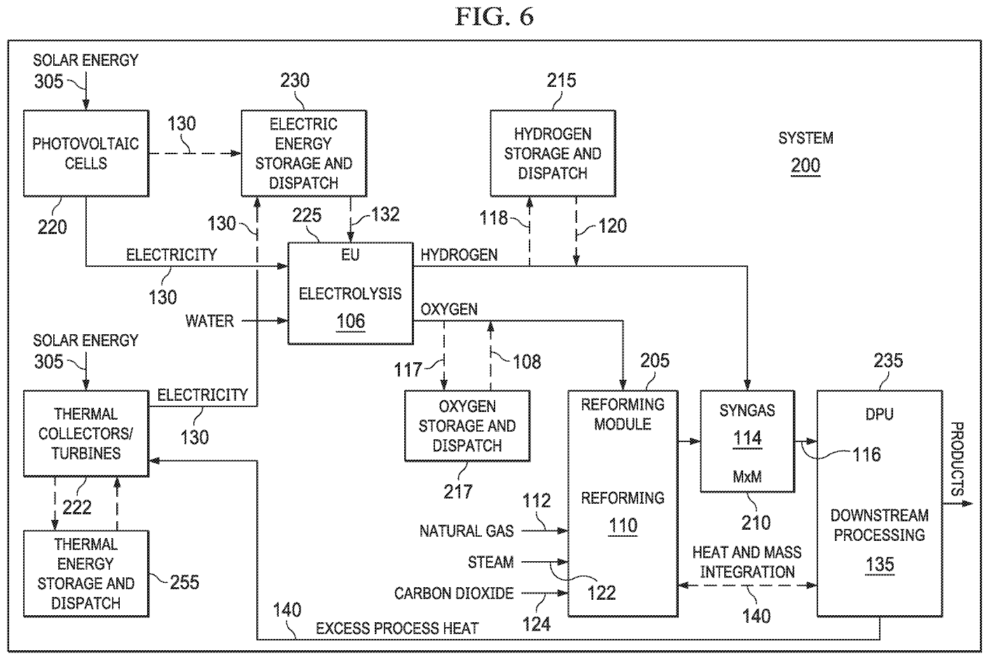

FIG. 6 presents a process flow and system block diagram of another example embodiment of the method and system for producing syngas in accordance the disclosure;

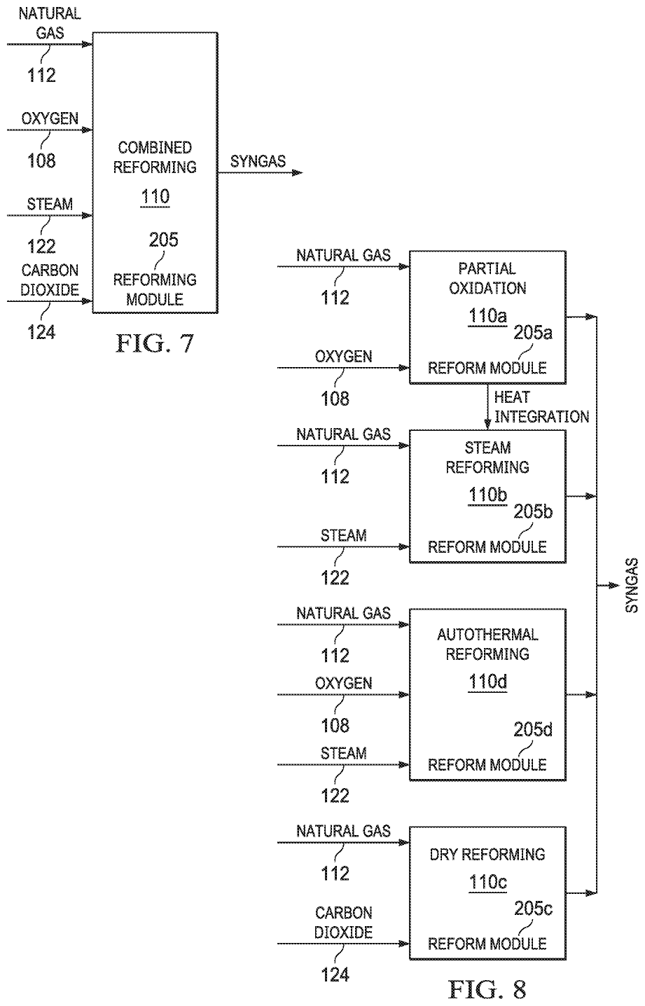

FIG. 7 presents a block diagram of syngas reforming in a combined reforming module accepting natural gas, oxygen gas, steam and carbon dioxide, such used in any of the process and system embodiments disclosed herein;

FIG. 8 presents a block diagram of syngas reforming in separate reforming modules accepting natural gas and one of oxygen gas, steam or carbon dioxide or natural gas and oxygen gas and steam, such as used in any of the process and system embodiments disclosed herein; and

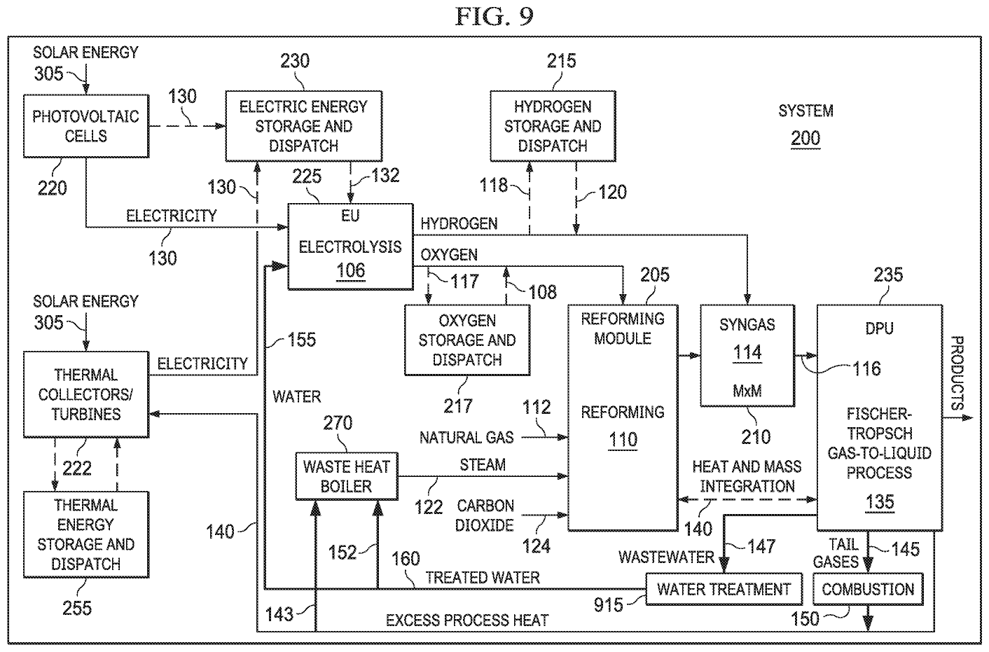

FIG. 9 presents a process flow and system block diagram of another example embodiment of the method and system for producing syngas, the system integrating heat and mass within the system in accordance with the disclosure.

In the Figures and text, similar or like reference symbols indicate elements with similar or the same functions and/or structures. The description and drawings merely illustrate the principles of the invention and based on the disclosure presented herein once skilled in the pertinent art would understand how to devise various arrangements that, although not explicitly described or shown herein, embody the principles of the inventions and are included within its scope. The term, “or,” as used herein, refers to a non-exclusive or, unless otherwise indicated. The various embodiments described herein are not necessarily mutually exclusive, as some embodiments can be combined with one or more other embodiments to form new embodiments.

### DETAILED DESCRIPTION

This disclosure presents a novel method and system design incorporating solar energy and water electrolysis systems in conjunction with established methane reforming processes, to demonstrate how solar energy can be captured and transferred to energy in the form of chemicals.

One embodiment of the disclosure is a method for producing syngas. FIG. 1 presents flow diagram of a method 100 for producing syngas in accordance with the disclosure.

The method 100 includes providing separate streams of oxygen gas (step 102) and hydrogen gas (step 104), the oxygen gas and the hydrogen gas generated from electrolysis of water (step 106). The method also includes introducing (e.g., dispatching) the separate stream of oxygen gas into a reforming module (step 108) configured to generate a reformed syngas feed (step 110), where the oxygen gas oxidizes natural gas supplied to the reforming module (step 112). The method further includes mixing the separate stream of hydrogen gas and the reformed syngas feed (step 114) to adjust a ratio of hydrogen gas to carbon monoxide gas (H₂:CO) to produce a syngas product feed (step 116).

In some embodiments the oxygen and hydrogen can be stored in containers and then dispatched from the containers as needed (steps 117, 118, respectively).

For instance, in support of step 110, as part of step 108, the oxygen can be introduced directly or dispatched from a container into the reforming module to support the generation of the reformed syngas feed.

For instance, in support of step 114, the separate stream of hydrogen gas provided in step 104 can be introduced directly or dispatched from a container as part of introducing a stream of hydrogen (step 120) into a mixing module for mixing with the reformed syngas feed generated in step 110.

In some embodiments, to facilitate adjustment of the H₂:CO ratio, the method 100 can further include feeding one or both of streams of steam (step 122) or carbon dioxide (step 124), into the reforming module.

In some embodiments of the method 100, energy for forming electricity to cause the electrolysis of water can be created (e.g., from solar energy) and supplied from a photovoltaic cell or from a thermal collector/turbine generation unit or from both (step 130). In some embodiments, the electricity and be stored and then later dispatched (step 132) to support the electrolysis of water in step 106.

As illustrated in FIG. 1 and as further described elsewhere herein, the syngas product feed generated in step 116 can be used in various downstream processing reactions (step 135).

In some embodiments, energy requirements to generate the reformed syngas feed in step 110 can be supplied from excess process heat (step 140) of such downstream processes or from heat-releasing reactions of such downstream processes.

Additionally or alternatively, in some embodiments, such excess process heat can be stored in a thermal energy storage system (step 142) that provides energy to a thermal collector/turbine generation unit that forms the electricity to cause the electrolysis of water in (step 130). Or such excess process heat can be directly provided to the thermal electricity generation unit (step 143).

As illustrated in FIG. 1, in some embodiments of the method 100, one or more of the downstream processing reactions steps 135 can generate tail gas (step 145) and/or produce or generate wastewater (step 147) which then leave the downstream processing unit.

In some such embodiments, the tail gases leaving the downstream processes of step 135 can be combusted (step 150) to generate at least some or all of the excess process heat of step 140, and, the excess process heat can be used provide heat (step 152) to heat water (step 154), such as the wastewater generated in step 147, to generate some or all of the steam feed to the reforming modules (step 122) or to heat the thermal collector/turbine generation unit (step 142) for forming electricity in step 130 to thereby cause the electrolysis of water (step 106), or be stored (step 142) for subsequent later use for these steps. For instance, the excess process heat can be provided to heat a boiler configured to receive the wastewater.

In some such embodiments, the wastewater generated in step 147 can be used to provide a feed of water (step 155) to an electrolysis unit that performs the electrolysis of water in step 106.

In some embodiments, the wastewater produced from the processing unit 235 (step 147) can be treated (step 160) before being provided as the feed of water (step 155) for electrolysis (step 106) and/or being used to generate the steam feed (step 122). For instance in some embodiments as part of treating, the wastewater can be boiled (step 154) to produce treated water (step 160).

As further disclosed below, in some embodiments of the method 100 it can be advantageous to adjust relative amounts of the separate streams of oxygen gas (steps 102, 108) and hydrogen gas (step 104) and the supply of natural gas (step 112) and the optional separate supplies of steam (step 122) and carbon dioxide (step 124), to facilitate providing a particular target ratio of H₂:CO in the syngas product feed (step 116). In some embodiments, the target ratio of H₂:CO can be a value in a range from about 1:1 to 3:1. For instance in some embodiment the target ratio of H₂:CO can be one of about 1:1 (e.g., 1:1±10% or ±1%) , or about 2:1 (e.g., 2:1±10% or ±1%) or about 3:1 (e.g., 3:1±10% or ±1%).

Another embodiment is a system for producing syngas. FIG. 2 presents a block diagram of an example system 200 for producing syngas in accordance with the disclosure. The system 200 includes a reforming module 205 and a mixing module 210 (M×M). The reforming modules 205 is configured to receive, and is supplied with, a stream of oxygen gas and a stream of natural gas. As disclosed elsewhere herein the oxygen gas oxidizes the natural gas generate a reformed syngas feed in the reforming module 205. The mixing module 210 is configured to receive, and is supplied with, the reformed syngas feed and a stream of hydrogen gas. As further discloses elsewhere herein these gas feeds can be adjusted to provide a ratio of hydrogen gas to carbon monoxide gas (H₂:CO) in a syngas product feed released from the mixing module 210. The stream of oxygen gas and the stream of hydrogen gas are generated from electrolysis of water.

Some embodiments of the system 200 can further include a hydrogen storage container 215 configured to dispatch the stream of hydrogen gas and an oxygen container 217 configured to dispatch the stream of oxygen gas.

One skilled in the pertinent art would be familiar with various types of commercially available reforming modules, mixing modules, gas storage containers, and plumbing to provide gas or liquid feeds.

Some embodiments of the system 200 can further include a photovoltaic cell 220 or a thermal collector/turbine generation unit 222 configured to provide electricity to generate the stream of hydrogen gas and the stream of oxygen gas formed by the electrolysis of the water. For instance, as familiar to those skilled in the pertinent art, in some embodiments, the photovoltaic (PV) cell can be one of a plurality of cell (e.g., crystalline silicon solar PV cells) in a plurality of photovoltaic panels. For instance, as familiar to those skilled in the pertinent art, in some embodiments, the thermal collector/turbine generation unit can include a plurality of solar collectors to collect, concentrate and convert solar energy into heat which can then be used by a plurality of thermal turbines to generate the electricity.

Some embodiments of the system 200 can further include an electrolysis unit 225 configured to generate the hydrogen gas and the oxygen gas from the electrolysis of water supplied to the electrolysis unit (e.g., either directly or indirectly from storage containers 215, 217) and from the electricity provided from the photovoltaic cell 220 or from the thermal collector/turbine generation unit 222.

One skilled in the pertinent art would be familiar with various types of commercially available electrolysis units, including Polymer Electrolyte Membrane/Proton Exchange Membrane (‘PEM’) cells, or, alkaline or other types of electrolyzers that can be connected to receive the electricity from the photovoltaic cell 220 or the thermal collector/turbine generation unit 222 or from such electricity dispatched from an electricity storage container 230 (e.g., one or more batteries). For instance, as familiar to those skilled in the pertinent art, the electrolysis unit 225 can include a plurality of PEM electrolyzer cells (e.g., a PEM stack) capable of producing several tonnes per day of H₂ gas given sufficient supplies of electric power and water.

As further illustrated in FIG. 2, some embodiments of the system 200 can further include a down-stream processing unit 235 (DPU). The DPU 235 is configured to receive the syngas product feed from the mixing module 210 where, as further disclosed herein, various downstream production chemicals are formed.

However, as disclosed herein, to reduce operational and raw material costs, heat or materials (e.g., waste material) generated by the DPU 235 can be advantageously used to support the function of other components of the system 200.

For instance, in some embodiments, mass or heat integration from the reforming module 205 and the DPU 235 can be used for heat integration (e.g., via heat transfer conduits 240, 242, 244, 246, 248) between a partial oxidation of methane and steam reforming of methane or dry reforming of methane reactions in the reforming module or for mass integration between oxygen produced from the electrolysis of water and the partial oxidation of methane reaction.

For instance, in some embodiments, heat transfer conduits 240, 242, 244 can be configured to transfer excess process heat generated in the DPU 235 to the reforming module 250 or to a thermal collector/turbine generation unit 222 of the system 200 or to a thermal storage container 255 thermally coupled to the generation unit 222.

In some embodiments, tail gas leaving the DPI 235 can be combusted in a combustion chamber 260, and the heat generated therefrom can be, or can be added to, the excess process heat (e.g., via conduit 246).

For instance, in some embodiments, the system 200 can further include a boiler 270 to receive wastewater from the DPU 235, the boiler 270 configured to deliver treated wastewater to an electrolysis unit 225 of the system 200.

Some such embodiments can further include a boiler (in some embodiments, the same boiler 270 or in other embodiment a second boiler 275) to receive the wastewater from the DPU 235, the boiler (e.g., one or both of boilers 270, 275) can be configured to convert the treated wastewater to steam and send the steam to the reforming module 205.

In some such embodiments, a heat transfer conduit 248 can be configured to transfer excess process heat generated in the DPU 235 or the combustion chamber 260 to the boiler 270 or to the second boiler 275 to support the generation of the steam or the treatment of the waste water.

As illustrated in FIG. 2, embodiments of the system 200 can further include containers (e.g., reservoir containers 280, 282, 284, respectively) to provide a steady supply of the natural gas, steam or carbon dioxide gases to support the function of the reforming module 205.

Any such embodiments of the system 200 or other systems embodiments as disclosed below can be a mobile system (e.g., mounted on a skid 290 that is transportable by a vehicle) and capable of being operational while independent of a power grid or of natural gas pipelines.

To demonstrate the applicability of the presented design, general economic benchmarking is provided to demonstrate how the presented design can be an economically viable method for energy storage.

Solar energy is the fastest growing method of energy production across the globe. Solar energy has the largest potential for energy on earth with a maximum theoretical potential of 89,300 TW of energy. To put this in perspective, theoretically the sun could provide the entire worldwide energy consumption (430 EJ) in 2011 in just ninety minutes. Due to large energy supply and potential of solar energy, it is critical to assess and consider solar energy in discussions on how to meet the world's growing energy demands

Shale gas, a non-conventional form of shale natural gas, is another resource that has been growing in production and utilization over the past several years. From 2010 to 2015, the use of shale gas nearly tripled, with Shale Gas Flow increasing from 5×10¹² ft³ to 15×10¹² ft³. There has been a rapid growth of shale gas production within the United States from 2007 to 2015.

Shale gas composition is made up of a variety of hydrocarbons, however the major component in shale gas plays is methane. The composition percentages for several major shale gas plays in the United States are shown in Table 1.

TABLE 1
Average shale gas component composition
for shale plays in the United States

| | C1 | C2 | C3 | | |
|---|---|---|---|---|---|
| Reservoir | (methane) | (ethane) | (propane) | CO₂ | N₂ |
| Barnett | 86.8 | 6.7 | 2.0 | 1.7 | 2.9 |
| Marcellus | 85.2 | 11.3 | 2.9 | 0.4 | 0.3 |
| Fayetteville | 97.3 | 1.0 | 0.0 | 1.0 | 0.07 |
| New Albany | 89.9 | 1.1 | 1.1 | 7.9 | 0.0 |
| Antrim | 62.0 | 4.2 | 1.1 | 3.8 | 29.0 |
| Haynesville | 95.0 | 0.1 | 0.0 | 4.8 | 0.1 |
| Eagle Ford | 74.6 | 13.8 | 5.4 | 1.5 | 0.2 |

Of these shale plays, it is anticipated that the Marcellus, Haynesville, and Eagle Ford will account for 60% of the cumulative production of shale gas in the United States.

The majority methane composition in shale gas is significant as methane can be used as a feed for many chemicals, including synthesis gas (‘syngas’). Syngas is a gaseous mixture of hydrogen and carbon monoxide that is commonly used to produce liquid fuels via the Fischer-Tropsch process. Additionally, syngas can be used to produce methanol and other various chemicals. The ratio of hydrogen to carbon monoxide gas (H₂:CO; mole ratio) can vary and is dependent on the desired product outcome. However, many of the chemicals, including those as a result from Fischer-Tropsch (e.g., liquid fuels) and methanol (used to synthesize, e.g., dimethyl ether, formaldehyde, acectic acid, MTBE, gasoline, methylmethacrylate, methyl chloride, methylamines, olefins) benefit from (e.g., require) a 2:1 H₂:CO ratio. For other chemicals, a ratio of 1:1 (used to synthesize, e.g., formic acid or acetic acid) or 3:1 (used to synthesize, e g , ammonia or hydrogen) can be beneficial.

Synthesis gas is traditionally produced by processes known as the Steam Reforming of Methane (‘SMR’), Partial Oxidation of Methane (‘PDX’), Autothermal Reforming (‘ATR’), which is a combination of SMR and PDX, and the Dry Reforming of Methane (‘DRM’). A combination of three of these methane reformers—SMR, PDX, and DRM—is known as Combined Reforming (‘CMR’) or tri-reforming. The reactions for SMR, PDX, and DRM are summarized in equations 1-3, respectively). All of these reactions utilize methane as a feed. With its large methane composition, shale gas has significant potential to be a key component in syngas production and monetization.

$$\begin{matrix}SMR \text{:} {CH}_{4} + {H}_{2} O \to 3 {H}_{2} + CO \\ Δ H = 206 kJ / mol & ( 1 ) \\ POX \text{:} {CH}_{4} + \frac{1}{2} {O}_{2} \to 2 {H}_{2} + CO \\ Δ H = - 36 kJ / mol & ( 2 ) \\ DRM \text{:} {CO}_{2} + {CH}_{4} \to 2 {H}_{2} + 2 CO \\ Δ H = 247 kJ / mol & ( 3 )\end{matrix}$$

These methane reforming and syngas production strategies have been extensively researched and are used in industry.

However, the invention summarized in this disclosure is unique due to how the methane reformers are being integrated with the incorporation of water electrolysis. Here, water electrolysis is specifically assessed due to its ability to produce high-purity streams of hydrogen and oxygen gasses. These gaseous products can be incorporated with syngas and syngas producing reactions.

Water electrolysis is typically used for hydrogen production and is responsible for 4% of the global hydrogen production. Historically, the significant energy requirements affiliated with water electrolysis have made it a cost-prohibitive technology. Current water electrolysis technologies require approximately 52 kWh to produce 1 kg of hydrogen. With an electricity cost of $0.06 per kWh, this translates to an additional cost, due to electricity requirements, of $0.35 per kg water. This is equivalent to $3.12 per kg of hydrogen. In respect to hydrogen economy and a hydrogen selling price of $2.00/kg, this is unprofitable as the electricity price alone exceeds the value of the product. The cost of water electrolysis can be ameliorated through several ways, including: (a) using cheaper electricity, (b) using more efficient water electrolysis technologies, (c) addressing applications of the gaseous oxygen product produced during water electrolysis, or using some combination of these recommendations.

The theoretical minimum amount of energy required to split one mole of water is 285.5 kJ, which is equivalent to 39.4 kWh per kg of hydrogen. Comparing this to the current standard of 52 kWh per kg of hydrogen, there is clearly plenty of opportunity for electrolyzer efficiency improvements. This efficiency issue is being actively researched with a demonstrated downward trend in the energy requirements for electrolysis for both Polymer Electrolyte Membrane/Proton Exchange Membrane (‘PEM’) and Alkaline electrolyzers.

Hydrogen gas is more than ten times more valuable than oxygen on a per weight basis, yet, value of the oxygen stream from water electrolysis is mistakenly often overlooked. However, the cost of oxygen production can be significant. High-purity oxygen is typically obtained through air separation using cryogenic separations or a pressure swing adsorption setup, both of which have their own affiliated equipment and operation costs. Considering the benefit of producing an oxygen stream is one of the factors that makes incorporation of water electrolysis in syngas production potentially economically viable. While oxygen has fewer direct energy applications than hydrogen, it still has value as it can be used as a product in the medical field or as a feed for the PDX reaction. In this design, using the oxygen product from water electrolysis as a feed for the PDX reaction has the benefit of being able to be produced on site and on demand as a function of direct mass integration.

The price of electricity plays a significant role in the economic feasibility of water electrolysis. Electricity has traditionally been produced through coal consuming turbines, and while this allows electricity to be relatively cheap, it is a natural resource consuming and CO₂ emitting process. As an alternative way to produce electricity, solar photovoltaics are being assessed. Historically, electricity produced using solar photovoltaics has not had a high economical potential. However, through worldwide developments, including contributions by the United States Department of Energy and the National Renewable Energy Lab, affordable electricity via photovoltaics is becoming a reality. One program series, the SunShot 2020 and SunShot 2030, has been working to bring the unsubsidized and levelized cost of utility-scale electricity produced by photovoltaics down to $0.06 per kWh by 2020 and $0.03 per kWh by 2030. These prices, a significant decrease from the current price of electricity at $0.10 per kWh, would be competitive with electricity prices from the grid.

The present disclosure encompasses the integration of two abundant resources—solar energy and shale gas—to store energy through the production of chemicals. The disclosure incorporates the previously referenced methane reformers—SMR, DRM, PDX, ATR—with water electrolysis and photovoltaics to produce syngas, which in turn can be used for various chemical and/or liquid fuel production. By coupling these specific methane reformers together with water electrolysis any desired H₂:CO syngas ratio can be achieved, and that desired H₂:CO ratio can be maintained, with varying feed availability.

This disclosure can be applicable to resources such as stranded shale gas due to it being able to produce product without relying on connections to a pipeline or power grid. However, this disclosure also has the ability to be integrated with existing syngas producing infrastructure to maintain a constant H₂:CO ratio. Furthermore, this disclosure incorporates heat and mass integration, including (but not limited to) heat integration between PDX and SMR or DRM reactions and mass integration between oxygen produced from water electrolysis and the PDX reaction.

A process flow diagram and block diagram of one embodiment of a method 100 for producing syngas using the proposed system 200 design is presented in FIG. 3.

As illustrated in FIG. 3, solar energy is collected photovoltaic cells 220, thermal collector/turbine generation unit 222) and used to create electricity (step 130). The energy to provide the electricity can be stored (e.g., electrical energy storage system 230, thermal energy storage system 255) until dispatch. Next, electricity is dispatched (step 132) to be used in water electrolysis (step 106, electrolysis unit, EU 225) to split water into the gaseous oxygen and hydrogen components. Both oxygen and hydrogen gases are stored (steps 117, 118, storage containers 217, 215, respectively) and dispatched (steps 108, 120, respectively) as necessary to the methane reform reactor(s) (e.g., reforming module 205) (oxygen) or to the syngas product directly (hydrogen). The shale gas (methane), carbon dioxide, and steam feeds (e.g., water vapor) are dispatched (steps 112, 334, 122, respectively) to the module(s) 205 where, based on the feed ratios, produce syngas in a pre-determined H₂:CO ratio (step 110). Syngas (e.g., a syngas product feed) can be then sent to a downstream processing unit, DPU 235 (step 116) for chemical or liquid fuel production (step 135) as applicable. Heat and mass integration are integrated and used where applicable in the module 205 or downstream processing unit 235 (step 140). Excess process heat can be stored (step 142) in the thermal energy storage system 255.

FIG. 4 provides an example of how heat and mass integration can be applied in a system 200 to support a downstream gas-to-liquid (GTL) Fischer-Tropsch process 135 analogous that described in the context of FIG. 3. As further illustrated in FIG. 4, excess process heat produced from the process unit 235 (step 140) may be used to provide heat (step 152) to produce the steam (step 122, e.g., via boiler 270) needed for reforming reactions (step 110) and/or provide heat (step 143) to supplement a solar-assisted heat generation unit 222 needed for the electric energy production via a turbine. Wastewater produced from the process unit 235 (step 147) can be treated (step 160, e.g., via second boiler 430) and then provided (e.g., to first boiler 270) to produce the steam (step 122) and/or to provide treated water (step 155) for electrolysis (step 106).

Initial Economic Benchmarking has been performed to demonstrate economic potential. First, an MISR (‘Metric for Inspecting Sales and Reactants’) has been performed on water electrolysis. The MISR, shown in equation 4, is a metric that measures the selling price of the product in respect to the purchase price of the materials. An MISR value greater than 1 indicates that the process has promise to be profitable while an MISR value less than 1 indicates that the gross product profit is less than the cost of the raw materials and the process should not be pursued.

$$MISR = \frac{\begin{matrix}{\sum }_{p = 1}^{Nproducts} Annual Productions Rate \\ of p * Selling price of p\end{matrix}}{\begin{matrix}{\sum }_{r = 1}^{Nreactants} Annual Feed Rate \\ of r * Purchase price of r\end{matrix}} \qquad ( 4 )$$

Here, the MISR for water electrolysis is performed. Because of the significant cost of electricity and value of oxygen, electricity is considered a purchased material and oxygen is considered a sold product in the MISR calculation.

FIG. 5 shows how electricity prices affect the MISR. It is also assumed that the purchase price of hydrogen is $2000/tonne, the selling price of oxygen is $110/tonne, and the purchase price of water is $8.00/tonne.

It can be seen that at $0.03/kWh, the goal price of electricity using the SunShot 2030 program, the MISR is 2.3, indicating there is potential for profit. At $0.07/kWh, the MISR is 1, indicating that $0.07/kWh is the break-even point where the cost of the products are equal to the cost of the purchased materials.

To illustrate the applicability of the overall system, a case study was performed to assess the MISR. The following conditions were assumed: Electricity is available at $0.03/kWh; Electrolyzer is not operating at theoretical maximum efficiency but at 50 kWh/kg of Hydrogen; Water Electrolysis unit operating at 5 tonnes H₂/day maximum; Desired syngas ratio is 2; Available feed is 500 kmol/hour of H₂O, CO₂, and CH₄, No heat integration. The purchase and selling price of materials are shown in Table 2. Moreover, the following feed in Table 3 was found to be profitable under these conditions (e.g., most) with an MISR of 4.24.

TABLE 2
Example purchase and selling prices for materials and products

| Materials | Purchased Prices ($/tonne) |
|---|---|
| Methane | 157.89 |
| Carbon Dioxide | 0.00 |
| Water | 8.00 |

| Products | Selling Prices ($/tonne) |
|---|---|
| Carbon Monoxide | 75.00 |
| Oxygen | 110.00 |
| Hydrogen | 2000 |

TABLE 3
Example feed using water electrolysis for a 2:1 H₂:CO ratio

| | Reactant | | | | | Product | | | | |
|---|---|---|---|---|---|---|---|---|---|---|
| Chemical | DMR | SMR | POX | ATR | WES | DMR | SMR | POX | ATR | WES |
| CH₄ | 199.45 | 300.55 | — | — | — | 2.136 | 13.82 | — | — | — |
| CO₂ | 199.45 | — | — | — | — | 0.746 | 2.95 | — | — | — |
| H₂O | — | 300.55 | — | — | 103.14 | 1.333 | 10.80 | — | — | — |
| H₂ | — | — | — | — | — | 393.240 | 862.94 | — | — | 103.14 |
| CO | — | — | — | — | — | 395.962 | 283.70 | — | — | — |
| O₂ | — | — | — | — | — | 0.024 | 0.04 | — | — | 51.57 |

This work introduces a new and integrated system for utilizing shale gas, solar energy, and water electrolysis for producing chemicals. In this way, a method of collecting and storing energy taken from the sun is created by storing solar energy in the form of chemicals. This work presented background information on the invention, a sample process flow diagram, initial economic benchmarking, and a case study to demonstrate the potential economic profitability of the system.

In addition to that stated above, Syngas is a common intermediate in the production of various liquid fuels and chemical. Syngas is traditionally made by using non-renewable resource with a high carbon footprint. This disclosure further creates a way to use cleaner technologies, including water electrolysis powered by solar energy and excess process heat, and a carbon dioxide consuming process (the dry reforming of methane or natural gas), to produce syngas. While water electrolysis and the dry reforming of methane are used, processes inclusive of steam reforming of natural gas, partial oxidation of methane, and autothermal reforming, are also evaluated. Selection of natural gas processing is dependent on the desired syngas H₂:CO ratio. Solar-assisted water electrolysis produces hydrogen (which can be blended with syngas to tune the hydrogen to carbon monoxide ratio) and oxygen which can be used for partial oxidation of shale gas. Mass integration is used so products of one process can be used as a feed for another process. This disclosure can also be skid mounted and mobile, allowing it to be transported to stranded gas reserves or to be used with conventional syngas and chemical production. Energy consumption is also considered, and this disclosure uses heat integration between the skid mounted processes, as well as any available downstream processes, to minimize overall energy requirements.

This disclosure is helpful, if not critical, as the globe transitions from conventional and natural resource and energy intensive syngas production, to cleaner and sustainable syngas production. Syngas is an essential product frequently used in industry, so it is imperative to consider cleaner production methods. It's ability to be skid mounted and mobile is unique as it can allow for syngas production on site at a shale gas well, and move from well to well. Additionally, as solar energy and water electrolysis continue to improve this disclosure allows succinct integration of these technologies with syngas production.

This disclosure is important because it will reduce (e g , minimize) greenhouse gas emissions while converting carbon dioxide to value added chemicals. The tunability of H₂:CO ratio offers a broad scope of applications to produce various chemicals. Because it can be mobile and/or skid mounted the system can be used to monetize stranded shale gas rather than relying on natural gas or shale gas transportation or pipeline access, minimizing greenhouse gas emissions, safety considerations, and costs affiliated with natural gas transportation. Additionally, integration of the water electrolysis, solar energy, and dry reforming of methane also allow greenhouse gas emissions to be minimized in comparison to traditional syngas production methods.

The disclosure is unique, in one aspect, because it revolves on six distinct points and novel integration schemes: it involves solar-assisted water electrolysis to produce separate streams of hydrogen (used to enrich syngas) and oxygen (used to produce syngas via partial oxidation), it integrates various forms of natural gas reforming, it takes advantage of material integration between the processes, it considers heat integration between exothermic and endothermic processes within the system as well with any downstream processes, it allows the specific H₂:CO ratio to be tunable to fit the needs of the downstream processes, and it can be constructed as a large scale process or a skid mounted mobile system. The disclosure is unique in other aspects as well.

Existing systems have yet to encompass even a few, let alone all the points listed above. While certain existing systems employ water electrolysis in respect to syngas production, such systems also emphasize the use of carbon dioxide electrolysis in conjunction with water electrolysis for syngas production. The present disclosure, in one embodiment, is different as it does not require/include carbon dioxide electrolysis. That said, carbon dioxide electrolysis is still within the purview of the present disclosure. Additionally, the water electrolysis this disclosure covers is not limited to use of a solid oxide electrolysis cell and can use polymer electrolyte membrane or other materials for electrolysis. Additionally, in one embodiment this disclosure emphasizes the effective utilization of solar energy not to just produce hydrogen (which is the common usage out of electrolysis) but to also utilize the produced oxygen in making syngas.

The overall process can be added to large-scale chemical production plants or can be installed as a skid mounted system and transported to stranded natural gas wells. Based on the desired downstream product, appropriate feeds for each of the respective processes could be adjusted to tune the final H₂:CO ratio.

FIG. 6 presents a block diagram representation of another embodiment of the proposed system 200. Solar energy is collected through photovoltaic cells 220 and thermal collectors followed by turbines of the unit 222 to produce electricity (step 130). To address the diurnal nature of solar energy, storage and dispatch systems 230, 255 may be installed to collect a portion of the electric and thermal energies and to dispatch them as needed. The electric energy (e.g., dispatched in step 132) may be used to induce water electrolysis (step 106) which results in the production of relatively pure streams of hydrogen and oxygen. Again, because of the diurnal nature of solar energy, portions of hydrogen and oxygen may be stored separately (e.g., containers 215, 217, respectively) for later dispatch. While most electrolysis systems focus on the use of either hydrogen or oxygen, the proposed system 200 can make full utilization of both streams. Oxygen is used in partial oxidation of shale gas (natural gas) to produce syngas according to the following reaction (natural gas is represented as methane for simplification):

CH₄+0.5 O₂=2 H₂+CO

Other forms of reforming to be used, e.g., in a combined reactor such as illustrated in FIG. 7 (reform module 205), or, in separate reactors, as illustrated by FIG. 8 (reform modules 205a, . . . , 205d), which may include partial oxidation (step 110a) or include: Steam reforming (step 110b):

CH₄+H₂O=3 H₂+CO

Dry reforming (step 110c):

CH₄+CO₂=2 H₂+2 CO

Because partial oxidation is exothermic and steam reforming is endothermic, a combination of the two reactions (referred to as autothermal reforming, step 110d) in FIG. 8) seeks to integrate the heat release and consumption.

As can be seen from the aforementioned stoichiometric reactions, the reforming steps 110a . . . 110d can produce different ratios of H₂:CO. Production of different chemicals requires specific ratios of H₂:CO. Therefore, the feed in each reformer may be adjusted to control the syngas H₂:CO ratio. Additionally, the separately produced hydrogen from electrolysis may be used as an independent variable to tune the H₂:CO ratio via blending.

Various schemes can be envisioned for integrating heat and mass within the system. FIG. 9 shows a block diagram of an embodiment of the system 200 having such integration schemes. For instance, in a Fischer-Tropsch GTL DPU 235, the excess process heat from the unit 235 (step 140) may be used to provide heat (step 152) to produce the steam (step 122, via boiler 270) needed for reforming (step 110) and provide heat (step 143) to supplement a solar-assisted heat generation unit 222 needed for the electric energy production via a turbine. The tail gases leaving the unit 235 (step 145) can also be utilized to produce thermal energy (via combustion step 150) which is combined with the excess process heat (step 140). Because the GTL process unit 235 produces a large flowrate of wastewater (step 147), mass integration can be used to treat the water (e.g., via water treatment unit 915) and to provide the treated water (step 160) both for electrolysis (step 106) and for steam production (step 122) needed for reforming (step 110).

Those skilled in the art to which this application relates will appreciate that other and further additions, deletions, substitutions and modifications may be made to the described embodiments.

What is claimed is:

1. A method for producing syngas, comprising:
providing separate streams of oxygen gas and hydrogen gas, the oxygen gas and the hydrogen gas generated from electrolysis of water;
introducing the separate stream of oxygen gas into a reforming module configured to generate a reformed syngas feed, wherein the oxygen gas oxidizes natural gas supplied to the reforming module; and
mixing the separate stream of hydrogen gas and the reformed syngas feed to adjust a ratio of hydrogen gas to carbon monoxide gas (H₂:CO) to produce a syngas product feed.

2. The method of claim 1, further including feeding one or both of steam or carbon dioxide into the reforming module.

3. The method of claim 1, wherein energy for forming electricity to cause the electrolysis of water is supplied from a photovoltaic cell or a thermal collector/turbine generation unit.

4. The method of claim 1, wherein energy requirements to generate the reformed syngas feed are supplied from excess process heat of downstream processes or from heat-releasing reactions of the downstream processes using the syngas product feed.

5. The method of claim 1, further including storing excess process heat from downstream processes or from heat-releasing reactions of the downstream processes using the syngas product feed in a thermal energy storage system that provides energy to a thermal collector/turbine generation unit that forms electricity to cause the electrolysis of water.

6. The method of claim 1, further including combusting tail gases leaving the downstream processes using the syngas product feed to generate excess process heat, the excess process heat used to heat water to generate a steam feed to the reforming modules or to heat a thermal collector/turbine generation unit for forming electricity to cause the electrolysis of water.

7. The method of claim 1, further including heating wastewater generated from downstream processes or from heat-releasing reactions of the downstream processes using the syngas product feed to produce steam that is fed in a separate stream to the reforming module.

8. The method of claim 1, further including providing excess process heat from downstream processes or from heat-releasing reactions of the downstream processes to a boiler configured to receive wastewater from a downstream processing unit containing the downstream processes or the heat-releasing reactions.

9. The method of claim 1, further including providing a feed of the water to an electrolysis unit, the water supplied from treated wastewater generated from downstream processes or from heat-releasing reactions of the downstream processes using the syngas product feed.

10. The method of claim 1, adjusting relative amounts of the separate streams of oxygen gas and hydrogen gas and the supply of natural gas to provide the ratio H₂:CO in the syngas product feed to a value in a range from about 1:1 to 3:1.

11. A system for producing syngas, comprising:
a reforming module configured to receive a stream of oxygen gas, wherein the oxygen gas oxidizes natural gas supplied to the reforming module to generate a reformed syngas feed; and
a mixing module configured to receive the reformed syngas feed and a stream of hydrogen gas to thereby adjust a ratio of hydrogen gas to carbon monoxide gas (H₂:CO) in a syngas product feed released from the mixing module, wherein the stream of oxygen gas and the stream of hydrogen gas are generated from electrolysis of water.

12. The system of claim 11, further include a hydrogen storage container configured to dispatch the stream of hydrogen gas and an oxygen container configured to dispatch the stream of oxygen gas.

13. The system of claim 11, further including a photovoltaic cell or a thermal collector/turbine generation unit configured to provide electricity to generate the stream of hydrogen gas and the stream of oxygen gas by the electrolysis of the water.

14. The system of claim 13, further including an electrolysis unit configured to generate the hydrogen gas and the oxygen gas from the electrolysis of water supplied to the electrolysis unit and from the electricity provided from the photovoltaic cell or the thermal collector/turbine generation unit.

15. The system of claim 11, further including a down-stream processing unit configured to receive the syngas product feed from the mixing module.

16. The system of claim 15, wherein mass or heat integration from the reforming module and the down-stream processing unit are used in for heat integration between a partial oxidation of methane and steam reforming of methane or dry reforming of methane reactions in the reforming module or for mass integration between oxygen produced from the electrolysis of water and the partial oxidation of methane reaction.

17. The system of claim 15, further including heat transfer conduits configured to transfer excess process heat generated in the down-stream processing unit to the reforming module or to a thermal collector/turbine generation unit of the system.

18. The system of claim 15, further including a boiler to receive wastewater from the down-stream processing unit, the boiler configured to deliver treated wastewater to an electrolysis unit of the system.

19. The system of claim 15, further including a boiler to receive wastewater from the down-stream processing unit, the boiler configured to convert the treated wastewater to steam and send the steam to the reforming module

20. The system of claim 11, wherein the system is skid mounted, mobile, and operational while independent of a power grid or of natural gas pipelines.
